(19) United States
(12) Patent Application Publication
(10) Pub. No.: US 2016/0283679 A1
(43) Pub. Date: Sep. 29, 2016

(54) Identifying And Ranking Individual-Level Risk Factors Using Personalized Predictive Models

(71) Applicant: International Business Machines Corporation, Armonk, NY (US)

(72) Inventors: Jianying Hu, Bronx, NY (US); Kenney Ng, Arlington, MA (US); Fei Wang, Ossining, NY (US)

(21) Appl. No.: 14/744,065

(22) Filed: Jun. 19, 2015

Related U.S. Application Data
(63) Continuation of application No. 14/665,154, filed on Mar. 23, 2015.

(51) Int. Cl. G06F 19/00; G06N 5/04; G06N 7/00; G06N 99/00

(52) U.S. Cl. CPC G06F 19/345; G06N 99/005; G06N 5/04; G06N 7/005

(57) ABSTRACT

Embodiments are directed to a method of identifying individual-level risk factors. The method identifies a set of global risk factors for a risk target from population data, and identifies, based on the set of global risk factors, members from the population data having at least one clinical trait within a predetermined range of at least one clinical trait of an individual of interest. The method trains a personalized predictive model for the risk target based on the set of global risk factors and the member from the population data having at least one clinical trait within the a predetermined range. The method determines, based on a relevancy assessment of each of the set of global risk factors for the individual of interest, a subset of the set of global risk factors, wherein the subset comprises a set of individual risk factors for the individual of interest.

### DOMESTIC PRIORITY

This application is a continuation of U.S. patent application Ser. No. 14/665,154, titled “IDENTIFYING AND RANKING INDIVIDUAL-LEVEL RISK FACTORS USING PERSONALIZED PREDICTIVE MODELS” filed Mar. 23, 2015, the content of which is incorporated by reference herein in its entirety.

### BACKGROUND

The present disclosure relates in general to risk factors for particular disease states. More specifically, the present disclosure relates to systems and methodologies for identifying and ranking individual-level risk factors using personalized predictive models.

Predictive modeling is often used in clinical and healthcare research. For example, predictive modeling has been successfully applied to the early detection of disease onset and the greater individualization of care. The conventional approach in predictive modeling is to build a single “global” predictive model using all the available training data, which is then used to compute risk scores for individual patients and to identify population wide risk factors. Recent work in the area of personalized medicine show that patient populations tend to be heterogeneous. Accordingly, each patient has unique characteristics, and it is therefore useful to have targeted, patient specific predictions, recommendations and treatments.

### SUMMARY

Embodiments are directed to a computer implemented method of identifying individual-level risk factors. The method includes identifying, by at least one processor circuit, a set of global risk factors for at least one risk target from a set of population data. The method further includes identifying, by the at least one processor circuit, based at least in part on the set of global risk factors, at least one member from the set of population data having at least one clinical trait within a predetermined range of at least one clinical trait of an individual of interest. The method further includes training, by the at least one processor, at least one personalized predictive model for the at least one risk target based at least in part on the set of global risk factors and the at least one member from the set of population data having at least one clinical trait within the a predetermined range. The method further includes determining, by the at least one processor, based at least in part on a relevancy assessment of each of the set of global risk factors for the individual of interest, a subset of the set of global risk factors, wherein the subset comprises a set of individual risk factors for the individual of interest.

Embodiments are further directed to a computer program product for identifying individual-level risk factors. The computer program product includes a computer readable storage medium having program instructions embodied therewith, wherein the computer readable storage medium is not a transitory signal per se. The program instructions are readable by at least one processor circuit to cause the at least one processor circuit to perform a method including identifying a set of global risk factors for at least one risk target from a set of population data. The method further includes identifying, based at least in part on the set of global risk factors, at least one member from the set of population data having at least one clinical trait within a predetermined range of at least one clinical trait of an individual of interest. The method further includes training at least one personalized predictive model for the at least one risk target based at least in part on the set of global risk factors and the at least one member from the set of population data having at least one clinical trait within the a predetermined range. The method further includes determining based at least in part on a relevancy assessment of each of the set of global risk factors for the individual of interest, a subset of the set of global risk factors, wherein the subset includes a set of individual risk factors for the individual of interest.

Embodiments are further directed to a computer system for identifying individual-level risk factors. The system includes at least one processor circuit configured to identify a set of global risk factors for at least one risk target from a set of population data. The system further includes the at least one processor circuit configured to identify, based at least in part on the set of global risk factors, at least one member from the set of population data having at least one clinical trait within a predetermined range of at least one clinical trait of an individual of interest. The system further includes the at least one processor circuit configured to train at least one personalized predictive model for the at least one risk target based at least in part on the set of global risk factors and the at least one member from the set of population data having at least one clinical trait within the a predetermined range. The system further includes the at least one processor configured to determine, based at least in part on a relevancy assessment of each of the set of global risk factors for the individual of interest, a subset of the set of global risk factors, wherein the subset includes a set of individual risk factors for the individual of interest.

Additional features and advantages are realized through the techniques described herein. Other embodiments and aspects are described in detail herein. For a better understanding, refer to the description and to the drawings.

### BRIEF DESCRIPTION OF THE DRAWINGS

The subject matter which is regarded as the present disclosure is particularly pointed out and distinctly claimed in the claims at the conclusion of the specification. The foregoing and other features and advantages are apparent from the following detailed description taken in conjunction with the accompanying drawings in which:

FIG. 1 depicts a diagram illustrating a system according to one or more embodiments;

FIG. 2 depicts a diagram illustrating a more detailed implementation of the system shown in FIG. 1;

FIG. 3 depicts an exemplary computer system capable of implementing one or more embodiments of the present disclosure;

FIG. 4 depicts a flow diagram illustrating a methodology according to one or more embodiments;

FIG. 5 depicts a diagram illustrating an example of global risk factors determined from a logistic regression model trained on all of the training patients;

FIG. 6 depicts a diagram illustrating an example of personalized risk factors determined according to one or more embodiments;

FIG. 7 depicts a diagram illustrating the performance of a personalized logistic regression classifier according to one or more embodiments; and

FIG. 8 depicts a computer program product in accordance with one or more embodiments.

In the accompanying figures and following detailed description of the disclosed embodiments, the various elements illustrated in the figures are provided with three or four digit reference numbers. The leftmost digit(s) of each reference number corresponds to the figure in which its element is first illustrated.

### DETAILED DESCRIPTION

Various embodiments of the present disclosure will now be described with reference to the related drawings. Alternate embodiments may be devised without departing from the scope of this disclosure. It is noted that various connections are set forth between elements in the following description and in the drawings. These connections, unless specified otherwise, may be direct or indirect, and the present disclosure is not intended to be limiting in this respect. Accordingly, a coupling of entities may refer to either a direct or an indirect connection.

As previously noted herein, predictive modeling has been successfully applied to the early detection of disease onset and the greater individualization of care. Predictive modeling is a name given to a collection of mathematical techniques having in common the goal of finding a mathematical relationship between a target, response, or “dependent” variable and various predictor or “independent” variables with the goal in mind of measuring future values of those predictors and inserting them into the mathematical relationship to predict future values of the target variable. Because these relationships are never perfect in practice, it is desirable to give some measure of uncertainty for the predictions. For example, a prediction interval may be assigned a level of confidence (e.g., 95%). Another task in the process is model building. Typically the available potential predictor variables may be organized into three groups: those unlikely to affect the response, those almost certain to affect the response and thus destined for inclusion in the predicting equation, and those in the middle which may or may not have an effect on the response. In contemporary patient diagnosis methodologies, the approach in predictive modeling is to build a single “global” predictive model using all the available training data, which is then used to compute risk scores for individual patients and to identify population wide risk factors. Recent work in the area of personalized medicine show that patient populations tend to be heterogeneous. Accordingly, each patient has unique characteristics, and it is therefore useful to have targeted, patient specific predictions, recommendations and treatments.

Accordingly, the present disclosure relates to systems and methodologies for identifying and ranking individual-level risk factors using personalized predictive models. One or more embodiments of the present disclosure provide a patient-specific or “personalized” predictive model for each patient. The disclosed model may be customized for an individual patient because it is built using information from the patient and from clinically similar patients. Because the disclosed personalized predictive models are dynamically trained for specific patients, such personalized predictive models can leverage the most relevant patient information and have the potential to generate more accurate risk assessments (e.g., scores) and to identify more relevant and informative patient-specific risk factors.

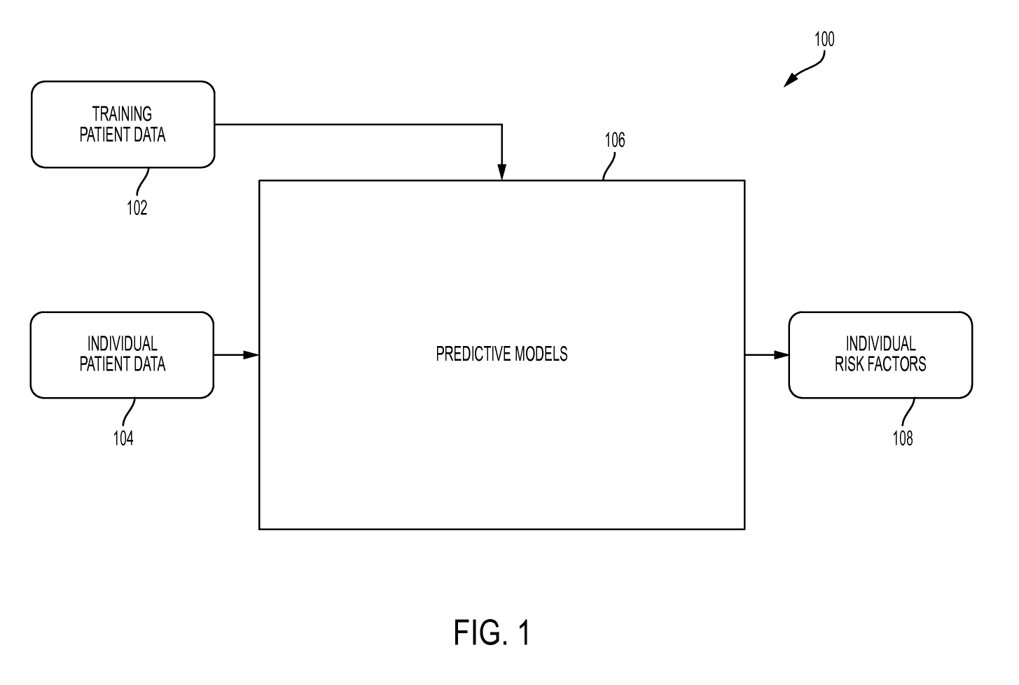

Turning now to the drawings in greater detail, wherein like reference numerals indicate like elements, FIG. 1 depicts a diagram illustrating a system 100 according to one or more embodiments. System 100 includes training patient data 102, individual patient data 104, predictive models 106 and individual risk factors 108, configured and arranged as shown. Training patient data 102 is taken from a large number of patients (e.g., several thousands) and includes risk target labels for training. Training patient data 102 includes electronic medical records (e.g., diagnosis, labs, medications, procedures, etc.), questionnaire data, genetics, activity/diet tracking data, and the like. In contrast to training patient data 102, individual patient data 104 is taken from the patient of interest. Individual patient data 104 includes electronic medical records (e.g., diagnosis, labs, medications, procedures, etc.), questionnaire data, genetics, activity/diet tracking data, and the like.

Training patient data 102 and individual patient data 104 are input to predictive models 106, which includes multiple types of predictive models (decision trees, logistic regression, Bayesian networks, random forests, etc.). Predictive models 106 are trained on the similar patient cohort and used to provide more robust estimates of the important risk factors that discriminate between the cases and controls. Thus, predictive models 106 select and rank individual patient specific risks to generate individual risk factors 108.

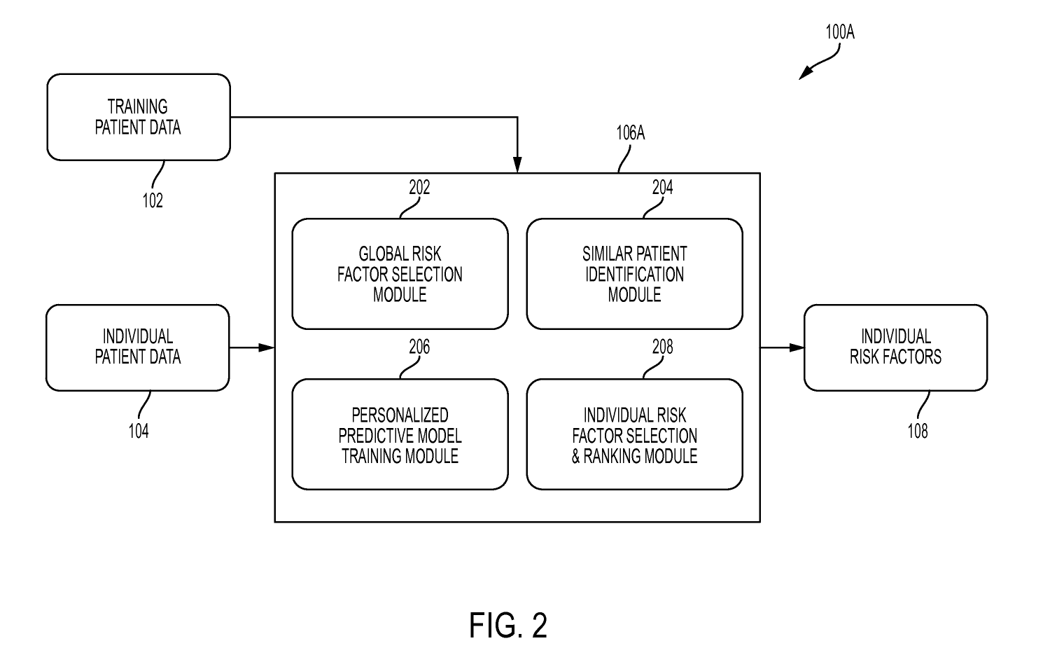

FIG. 2 depicts a diagram illustrating a system 100A, which is a more detailed implementation of system 100 shown in FIG. 1. More specifically, in system 100A, predictive models 106 is implemented as a global risk factor selection module 202, a similar patient identification module 204, a personalized predictive model training module 206 and an individual risk factor selection and ranking module 208. Global risk factor selection module 202 uses the training patient data to identify global risk factors for the specified risk target (e.g., heart failure, diabetes, chronic obstructive pulmonary disease, etc.). Standard feature selection approaches (e.g., filter, wrapper, embedded, ensemble) with different discrimination metrics may be used. Similar patient identification module 204 identifies, from the training patient data set, a cohort of clinically similar case and control patients to the individual target patient. A number of different distance or similarity measures based on the global risk factors may be used, including but not limited to rule based similarity constraints, target independent measures such as Euclidean, Mahalanobis, Manhattan distance and the like, or target specific (metric learning) measures that are trained on a similar training patient data set. Additional details of identifying similar patients are disclosed in a publication by Wang F, Sun J, Li T, Anerousis N, titled “Two Heads Better Than One: Metric+Active Learning and its Applications for IT Service Classification,” ICDM '09 (2009), p. 1022-7, the entire disclosure of which is incorporated herein in its entirety.

Personalized predictive model training module 206 trains multiple different predictive model classifiers (logistic regression, decision tree, Bayesian networks, support vector models, random forests, etc.) on the risk target using the cases and controls in the similar patient cohort. Individual risk factor selection and ranking module 208 selects individual patient risk factors by re-ranking the global risk factors based on utility assessments (e.g., scores) derived from the weights assigned to each risk factor by the trained models. These can be the beta coefficients and P-values in logistic regression classifiers, and/or the variable importance scores in decision tree and random forest classifiers, for example.

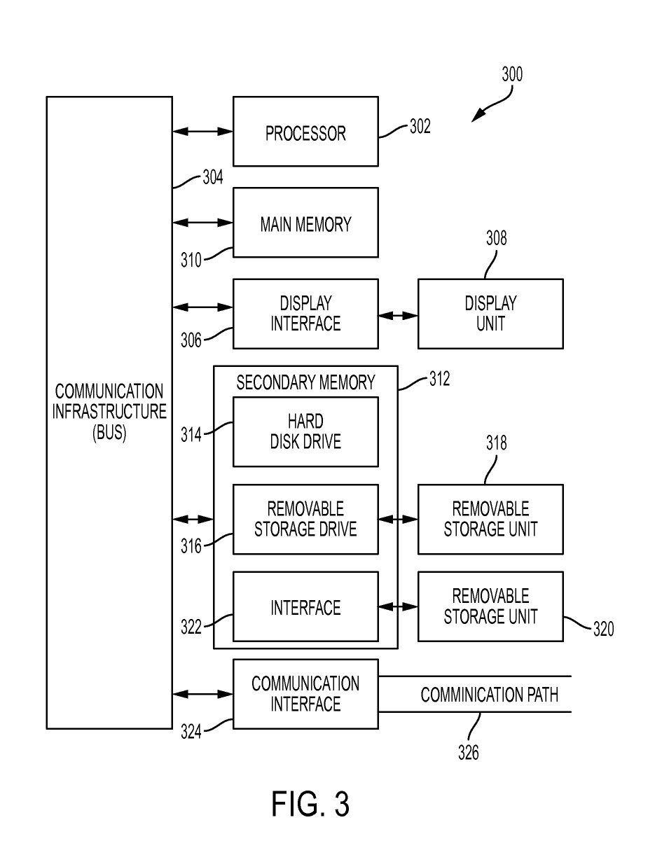

FIG. 3 illustrates a high level block diagram showing an example of a computer-based information processing system 300 useful for implementing one or more embodiments of the present disclosure. Although one exemplary computer system 300 is shown, computer system 300 includes a communication path 326, which connects computer system 300 to additional systems (not depicted) and may include one or more wide area networks (WANs) and/or local area networks (LANs) such as the Internet, intranet(s), and/or wireless communication network(s). Computer system 300 and additional system are in communication via communication path 326, e.g., to communicate data between them.

Computer system 300 includes one or more processors, such as processor 302. Processor 302 is connected to a communication infrastructure 304 (e.g., a communications bus, cross-over bar, or network). Computer system 300 can include a display interface 306 that forwards graphics, text, and other data from communication infrastructure 304 (or from a frame buffer not shown) for display on a display unit 308. Computer system 300 also includes a main memory 310, preferably random access memory (RAM), and may also include a secondary memory 312. Secondary memory 312 may include, for example, a hard disk drive 314 and/or a removable storage drive 316, representing, for example, a floppy disk drive, a magnetic tape drive, or an optical disk drive. Removable storage drive 316 reads from and/or writes to a removable storage unit 318 in a manner well known to those having ordinary skill in the art. Removable storage unit 318 represents, for example, a floppy disk, a compact disc, a magnetic tape, or an optical disk, etc. which is read by and written to by removable storage drive 316. As will be appreciated, removable storage unit 318 includes a computer readable medium having stored therein computer software and/or data.

In alternative embodiments, secondary memory 312 may include other similar means for allowing computer programs or other instructions to be loaded into the computer system. Such means may include, for example, a removable storage unit 320 and an interface 322. Examples of such means may include a program package and package interface (such as that found in video game devices), a removable memory chip (such as an EPROM, or PROM) and associated socket, and other removable storage units 320 and interfaces 322 which allow software and data to be transferred from the removable storage unit 320 to computer system 300.

Computer system 300 may also include a communications interface 324. Communications interface 324 allows software and data to be transferred between the computer system and external devices. Examples of communications interface 324 may include a modem, a network interface (such as an Ethernet card), a communications port, or a PCM-CIA slot and card, etcetera. Software and data transferred via communications interface 324 are in the form of signals which may be, for example, electronic, electromagnetic, optical, or other signals capable of being received by communications interface 324. These signals are provided to communications interface 324 via communication path (i.e., channel) 326. Communication path 326 carries signals and may be implemented using wire or cable, fiber optics, a phone line, a cellular phone link, an RF link, and/or other communications channels.

In the present disclosure, the terms “computer program medium,” “computer usable medium,” and “computer readable medium” are used to generally refer to media such as main memory 310 and secondary memory 312, removable storage drive 316, and a hard disk installed in hard disk drive 314. Computer programs (also called computer control logic) are stored in main memory 310 and/or secondary memory 312. Computer programs may also be received via communications interface 324. Such computer programs, when run, enable the computer system to perform the features of the present disclosure as discussed herein. In particular, the computer programs, when run, enable processor 302 to perform the features of the computer system. Accordingly, such computer programs represent controllers of the computer system.

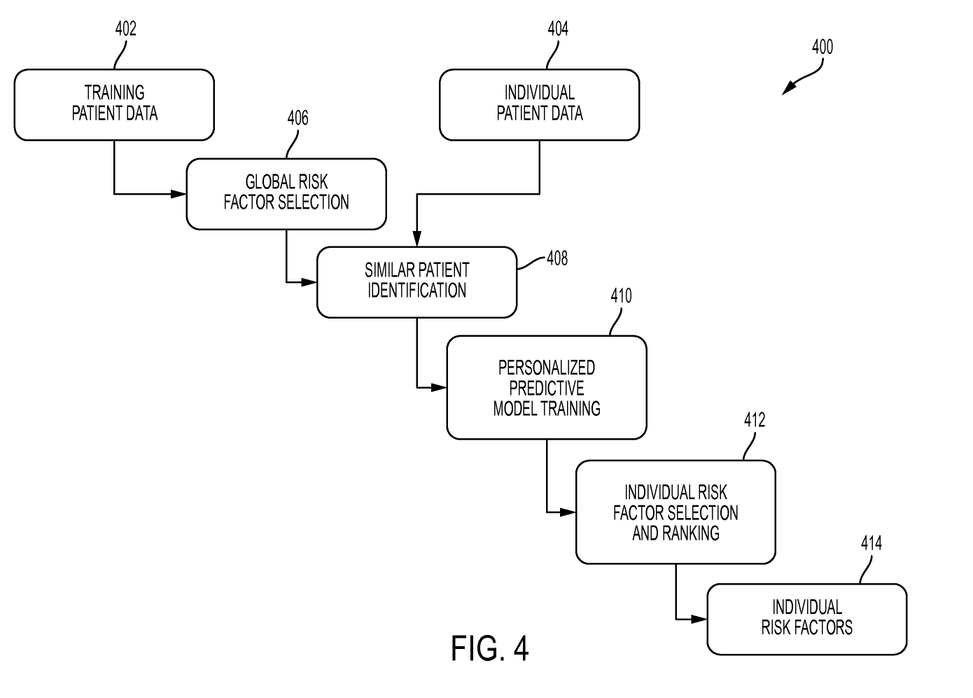

FIG. 4 depicts a flow diagram illustrating a methodology 400 according to one or more embodiments. Methodology 400 begins at block 402 by gathering training patient data taken from a large number of patients (e.g., several thousands) and including risk target labels for training Training patient data includes electronic medical records (e.g., diagnosis, labs, medications, procedures, etc.), questionnaire data, genetics, activity/diet tracking data, and the like. Methodology 400 further begins at block 404 by gathering individual patient data, which includes electronic medical records (e.g., diagnosis, labs, medications, procedures, etc.), questionnaire data, genetics, activity/diet tracking data, and the like. Block 406 identifies from the training patient data a set of global risk factors for the risk target. Block 408 uses the identified set of global risk factors, along with the individual patient data, to identify for an individual patient a cohort of clinically similar patients using a trainable similarity measure based at least in part on the global risk factors. Thus, block 408, in effect, identifies from the training patient data the training patients that are similar to the individual patient of interest. Block 410 trains one or more personalized predictive models for the risk target based at least in part on the similar patient cohort and the global risk factors. Thus, block 410 builds a model that will predict a risk of a particular diseases onset for a particular patient using only data from patients that have been determined to be similar to the particular patient. Block 412 looks at the model that has been trained in block 410. The trained model in block 410 includes the set of risk factors (which is typically a subset of the global risk factors) that the model has deemed important for assessing the risk for the particular patient, along with some form of a weighting factor to identify the importance of a given risk factor. Block 412 identifies the risk factors that were deemed important by the personalized predictive model training in block 410 by re-ranking the global risk factors based at least in part on a utility assessment (e.g., a score) determined by combining the weights assigned to each risk factor by the trained predictive models. In one or more embodiments, block 412 may determine a contribution of the set of risk factor in each of the trained personalized predictive models and combine the trained personalized predictive models into a composite score. Block 414 outputs the individual risk factors developed at block 412.

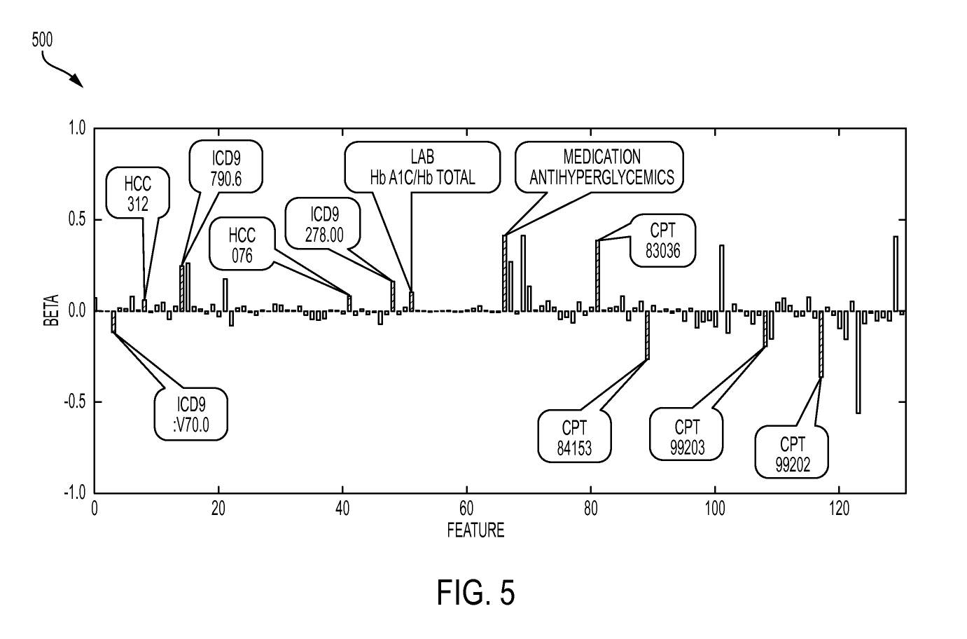

FIG. 5 illustrates a global risk factor profile 500 that may result from an application of system 100 (shown in FIGS. 1 and 2) and/or methodology 400 (shown in FIG. 4). Across the horizontal axis are features (or risk factors), and across the vertical axes values that have been associated with each feature. In developing global risk factor profile 500 filters are applied including a filter that filters out features having a low statistical significance, for example, features having a high P-value (e.g., P-value >0.05) are excluded. After applying the filters, the features may be plotted on global risk factor profile 500, from which the most important features can be readily identified. Examples of the identified most relevant risk factors in global risk factor profile 500 are annotated (e.g., HCC 312, ICD9 790.6, etc.).

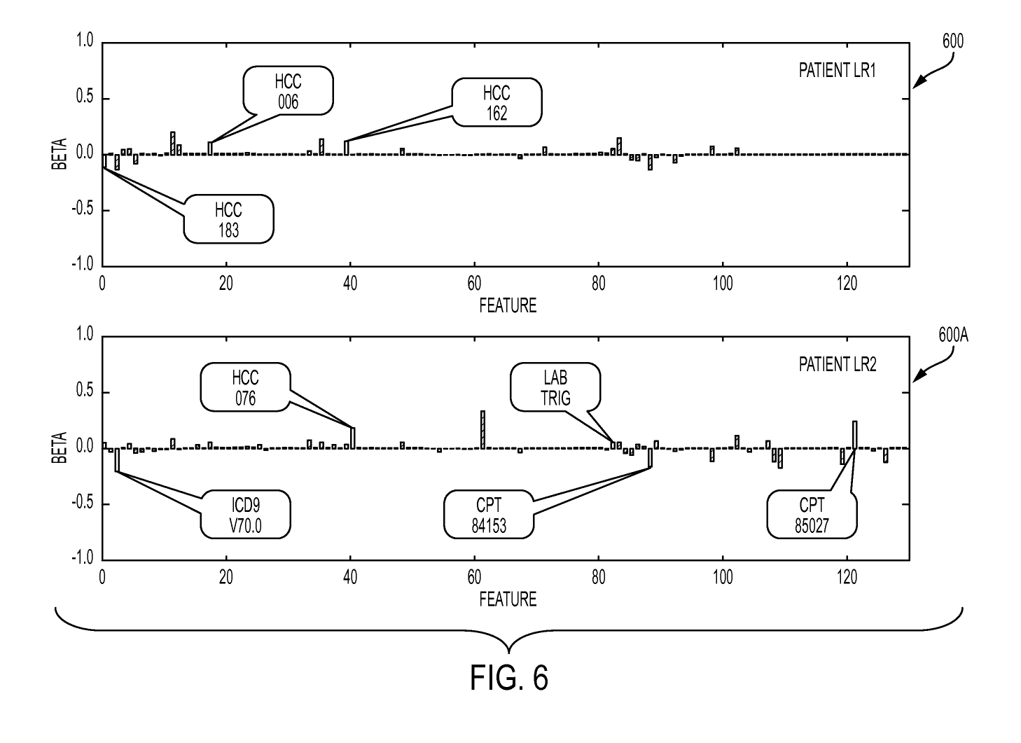

FIG. 6 illustrates personalized risk factor profiles 600, 600A that may result from an application of system 100 (shown in FIGS. 1 and 2) and/or methodology 400 (shown in FIG. 4). Personalized risk factor profiles are shown for two patients, LR1 and LR2, however, it is understood that personalized risk factor profiles may be developed and compared graphically for multiple individual patients. Referring not to each personalized risk factor profile, across the horizontal axis are features (or risk factors), and along the vertical axes are values that have been associated with each feature. In developing personalized risk factor profiles 600, 600A filters are applied including a filter that filters out features having a low statistical significance, for example, any feature having a high P-value (e.g., P-value >0.05) is excluded. After applying the filters, the features may be plotted on personalized risk factor profile 600, from which the most important features can be readily identified. Examples of the identified most relevant risk factors in personalized risk factor profile 600 are annotated (e.g., HCC 076, HCC 006, etc.).

Example implementations of one or more embodiments will now be described in order to further illustrate the present disclosure. The present disclosure extends the investigation and analysis of personalized predictive models along a number of dimensions, including using a trainable similarity metric to find clinically similar patients, creating personalized risk factor profiles by analyzing the parameters of the trained personalized models and clustering the risk factor profiles to facilitate an analysis of the characteristics and distribution of the patient specific risk factors. A 15,038 patient cohort was constructed from an anonymous longitudinal medical claims database consisting of four years of data covering over 300,000 patients. 7,519 patients with a diabetes diagnosis in the last two years but not in the first two years were identified as incident cases. Each case was paired with a matched control patient based on age (+/−5 years), gender and primary care physician resulting in 7,519 control patients without any diabetes diagnosis in all four years. The patients' diagnosis information, medication orders, medical procedures and laboratory tests from the first two years of data were used in the present example.

A feature vector representation for each patient was generated based on the patient's longitudinal data. This data can be viewed as multiple event sequences over time (e.g., a patient can have multiple diagnoses of hypertension at different dates). To convert such event sequences into feature variables (or risk factors), an observation window (e.g. the first two years) is specified. Then all events of the same feature within the window are aggregated into a single or small set of values. The aggregation function can produce simple feature values like counts and averages or complex feature values that take into account temporal information (e.g., trend and temporal variation). In this example, basic aggregation functions are used, for example a count for categorical variables (diagnoses, medications and procedures) and a mean for numeric variables (lab tests). This results in over 8500 unique feature variables. To reduce the size of the feature space, feature selection is performed using the information gain measure to select the top features for each feature type, for example 50 diagnoses, 50 procedures, 15 medications and 15 lab tests for a total of 130 features.

Personalized predictive modeling involves the following processing steps: receive a new test patient; identify a cohort of K similar patients from the training set using a patient similarity measure; select a subset of the features using information from the test patient and the cohort of K similar patients; train a personalized predictive model using the similar patient cohort; compute a risk score for the new test patient using the trained personalized predictive model; and analyze the trained personalized predictive model to create a personalized risk profile.

A number of different similarity measures can be used to identify the cohort of patients from the training set that are most clinically similar to the test patient. In general similarity measures identify, based at least in part on the set of global risk factors, at least one member from the set of population data having at least one clinical trait within a predetermined range of at least one clinical trait of an individual of interest. The set of population data includes, but is not limited to, a diagnosis, a lab result, a medication, a procedure, a hospitalization record, a response to a questionnaire, genetic information, microbiome data and self-tracked actigraphy data. In the present example, a trainable similarity measure called Locally Supervised Metric Learning (LSML) that is customizable for a specific target condition is used (see, Wang F, Sun J, Li T, Anerousis N., “Two Heads Better Than One: Metric+Active Learning and its Applications for IT Service Classification,” Ninth IEEE International Conference on Data Mining, (2009) ICDM p. 1022-7). A trainable metric is important because different clinical scenarios will likely require different patient similarity measures. For example, two patients that are similar to each other with respect to one disease target, e.g., diabetes, may not be similar at all for a different disease target such as lung cancer. The use of static similarity measures, e.g., Euclidean or Mahalanobis, for all target conditions may not be optimal. In the present example, an LSML similarity measure is trained for the diabetes disease onset target and then used to find the most clinically similar patients. This is compared to selecting patients based on the Euclidean distance measure and also random selection.

Using only the K most similar patients from the training set can reduce the amount of data available for training a personalized predictive model. Reducing the dimensionality of the feature vectors by selecting a subset of the initial features can help compensate for this. A number of approaches can be used to do this including performing conventional feature selection on the similar patient training cohort using an information gain or Fisher score. In the present example, a simple filtering heuristic is used such that the selected features consist of the union of the features that occur in the test patient feature vector, along with all features that occur in two or more feature vectors from the K most similar patients. The goal here is to ensure that only features that can impact the test patient are included.

For each patient, a logistic regression (LR) predictive model was dynamically trained using data from case and control patients that are clinically similar to the target patient based on the LSML similarity measure. The personalized predictive model was then used to compute a score (the risk of diabetes disease onset) for that patient. Predictive modeling experiments were performed using 10-fold cross validation and performance was measured using the standard AUC (area under the ROC curve) metric. AUC and 95% confidence intervals (CIs) are reported.

After training, the parameters in the predictive model are analyzed to identify the important risk factors captured by the model and used to create a “risk factor profile” for the patient(s) represented by the model. For the logistic regression model, the beta coefficient for each feature captures the change in the log odds for a unit change in that feature. In addition to the value of the coefficient, the significance of the coefficient can be assessed by computing the Wald statistic and the corresponding P-value. The important risk factors are the features with statistically significant, large magnitude coefficients. The beta coefficient values of these selected features can then be used to create the risk factor profile. For the global predictive model, only a single “population wide” risk factor profile can be derived. For the personalized predictive models, a risk factor profile is derived for each patient resulting in a large number of profiles. In this case, it is useful to examine the risk profiles individually as well as the distribution of the risk profiles across the patient population. Exploring and comparing the individual profiles allows one to pinpoint the risk factor differences among the patients. Examining the distribution of the profiles provides a global view of their behavior and relationships. One scalable approach that can support both individual comparisons and global distributional analysis is to perform agglomerative hierarchical clustering on the risk profiles. An analysis of the clustering results can provide insight into the characteristics and distribution of the profiles. One can assess the degree of similarity and difference of the risk factors for different patients. In addition, it may be possible to discover any structural relationships in the patient population with respect to common risk factors identified by the personalized models.

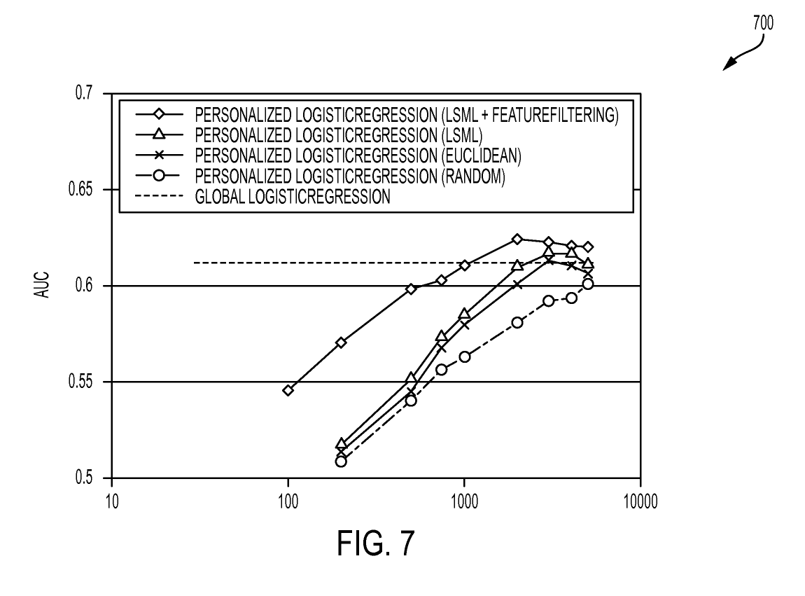

Performance of the personalized logistic regression classifier in terms of AUC as a function of the number of nearest neighbor training patients is shown in FIG. 7. There are four curves corresponding to four different configurations. In addition, the performance of the global logistic regression model (--) is shown for reference. First, as a baseline, K randomly selected patients are used for training the personalized model (∘). Performance steadily increases towards the global model performance as the number of training patients increases. This behavior is expected because for parametric models such as logistic regression, there needs to be sufficient data for the model parameters to be properly trained. Second, instead of selecting patients randomly, the Euclidean distance metric is used to select the K most similar patients for training (x). For a fixed number of training patients, similarity based selection is consistently better than random selection. Also, performance starts to level off after about 3000 training patients, suggesting that there is little to gain from using more dissimilar patients. Third, the LSML similarity metric is used to select the K most similar patients for training (Δ). Performance using a custom trained similarity measure is better than using a static measure for all values of K. Fourth, the dimensionality of the feature vectors is reduced using the filtering approach described earlier (⋄). This reduces the training data requirements on the model and results in significant performance improvements, especially for smaller values of K. Again, there is a diminishing return for using more dissimilar training patients as performance levels off for values of K larger than 2000. Performance of the personalized models is comparable to the global model (AUC: 0.611, 95% CI: 0.605-0.617) at K=1000 and better than the global model for larger values of K (AUC: 0.624, 95% CI: 0.617-0.631 at K=2000).

To facilitate the analysis of the characteristics and distribution of the patient specific risk factors, agglomerative hierarchical clustering (using a Euclidean distance measure) may be performed on the personalized risk factor profiles. For example, a hierarchical heat map plot may be constructed showing the top risk factors identified by the personalized predictive models for as many as 500 randomly selected patients. Patient specific risk factor profiles (e.g., the columns in the heat map) are clustered along the horizontal axis. The individual risk factors are clustered along the vertical axis. The color in the heat map may be selected to correspond to the risk factor score values (e.g., beta coefficient values) in the patient risk profiles. Analysis of the risk factor profile clusters shows that some patients share very similar risk factors and are grouped together in the same cluster whereas other patients have very different and almost non-overlapping risk factors and belong to groups that are far apart in the cluster tree. Patients with certain risk factor profiles have consistently higher risk scores (which may be shown as vertical bars along the bottom horizontal axis). For example, patients with high values for “PROCEDURE:CPT:83086 [glycosylated hemoglobin test]” and “LAB:hemoglobin alc/hemoglobin.total” in their risk profiles have much higher risk scores than those with low values. The personalized risk factors for each patient can also differ from the risk factors captured by the global model. Indeed, a large number of risk factors not captured by the global model are identified in the personalized models as useful predictors. The risk factor clusters along the vertical axis can be used to identify groups of risk factors that have high co-occurrence rates across patients. FIG. 6 depicts one example of the personalized risk profile 600 that would form one column of a hierarchical heat map plot showing the top risk factors identified by the personalized predictive models for multiple randomly selected patients.

Thus, it can be seen from the foregoing description and illustration that one or more embodiments of the present disclosure provide technical features and benefits. For a given individual patient, a unique set of case and control training patients (the similar patient cohort) for a risk target is dynamically determined using patient similarity. Multiple types of predictive models (decision trees, logistic regression, Bayesian networks, random forests, etc.) are trained on the similar patient cohort and used to provide more robust estimates of the important risk factors that discriminate between the cases and controls. Individual patient specific risks are selected and ranked based on utility scores determined by combining the weights assigned to each risk factor by the different trained personalized predictive models.

Accordingly, patient specific personalized predictive models trained using a smaller set of data from patients that are clinically similar to the query patient in accordance with one or more embodiments of the present disclosure can perform better than a global predictive model trained using all the training data. Unlike statically trained global models, personalized models are trained dynamically and can leverage the most relevant information available in the patient record. Personalized predictive models can be analyzed to identify risk factors that are important for the individual patient and used to create personalized risk factor profiles. Cluster analysis of the risk profiles show different groups of patients with similar risks and differences between the individual and global risk factors. Once identified, the patient specific risk factors may be leveraged to support better targeted therapies, customized treatment plans and other personalized medicine applications. Accordingly, the operation of a computer system implementing one or more of the disclosed embodiments can be improved.

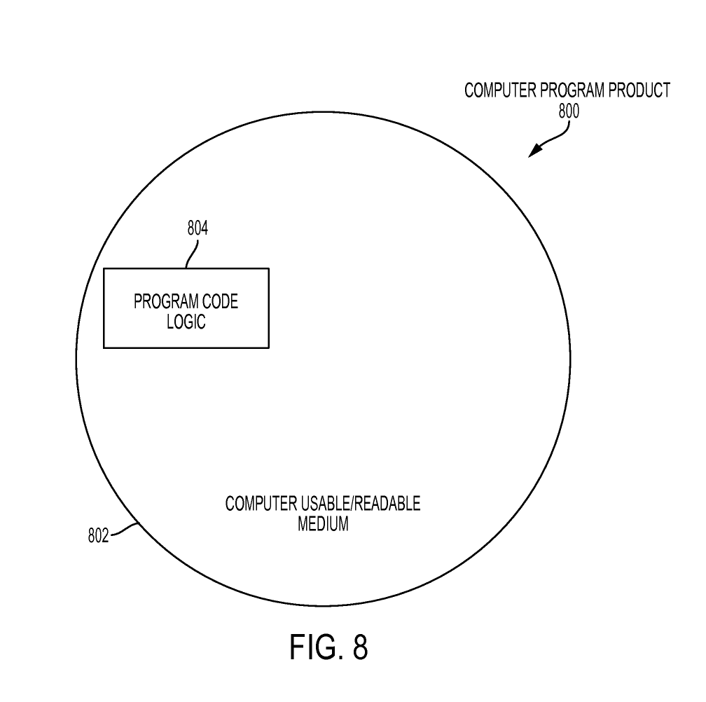

Referring now to FIG. 8, a computer program product 800 in accordance with an embodiment that includes a computer readable storage medium 802 and program instructions 804 is generally shown.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

It will be understood that those skilled in the art, both now and in the future, may make various improvements and enhancements which fall within the scope of the claims which follow.

What is claimed is:

1. A computer implemented method of identifying individual-level risk factors, the method comprising:
identifying, by at least one processor circuit, a set of global risk factors for at least one risk target from a set of population data;
identifying, by the at least one processor circuit, based at least in part on the set of global risk factors, at least one member from the set of population data having at least one clinical trait within a predetermined range of at least one clinical trait of an individual of interest;
training, by the at least one processor, at least one personalized predictive model for the at least one risk target based at least in part on the set of global risk factors and the at least one member from the set of population data having at least one clinical trait within the a predetermined range; and
determining, by the at least one processor, based at least in part on a relevancy assessment of each of the set of global risk factors for the individual of interest, a subset of the set of global risk factors, wherein the subset comprises a set of individual risk factors for the individual of interest.

2. The method of claim 1, wherein the relevancy assessment comprises a score that represents a relevance level of the subset to the individual of interest.

3. The method of claim 1, wherein the identifying the at least one member from the population data comprises using target specific metric learning measures trained with the population data.

4. The method of claim 1, wherein the identifying the at least one member from the population data comprises identifying case and control individuals separately and merging them.

5. The method of claim 1, wherein training the at least one personalized predictive model comprises at least one of the following statistical classification methodologies:
a logistic regression;
a decision tree;
a random forest; and
a Bayesian network.

6. The method of claim 1, wherein the determining comprises determining at least one contribution of the set of risk factor in each of the at least one trained personalized predictive model and combining the at least one contribution into a composite score.

7. The method of claim 1, wherein the set of population data comprises at least one of the following: a diagnoses, a lab result, a medication, a procedure, a hospitalization record, a response to a questionnaire, genetic information, microbiome data and self-tracked actigraphy data.
